(19) United States
(12) Patent Application Publication
(10) Pub. No.: US 2013/0326322 A1
(43) Pub. Date: Dec. 5, 2013

(54) SEMI-AUTOMATED PROCESSES TO MANAGE CONSTRUCTION WORK PACKAGES

(71) Applicants: Nikhil Chaubey, Greenville, SC (US); Austin Higgs, Simpsonville, SC (US); Mark Gosine, Simpsonville, SC (US); Kevin W. Clark, Simpsonville, SC (US); Richard Jerry Saine, Easley, SC (US)

(72) Inventors: Nikhil Chaubey, Greenville, SC (US); Austin Higgs, Simpsonville, SC (US); Mark Gosine, Simpsonville, SC (US); Kevin W. Clark, Simpsonville, SC (US); Richard Jerry Saine, Easley, SC (US)

(73) Assignee: FLUOR TECHNOLOGIES CORPORATION, Aliso Viejo, CA (US)

(21) Appl. No.: 13/486,259

(22) Filed: Jun. 1, 2012

(51) Int. Cl. G06F 17/00

(52) U.S. Cl. 715/221

(57) ABSTRACT

A method for semi-automation of management of work packages associated with construction projects is disclosed. Sets of printed forms are generated by the system based on the contents of work packages selected by the user. Information related to the work package is entered into data fields in the printed forms in the field, and uploaded to a database by scanning the printed forms. The database may be utilized to generate reports, such as those related to regulatory issues or project status.

### FIELD OF THE INVENTION

The field of the invention is the automation of construction work flow.

### BACKGROUND

Plant and other building construction is an enormously complicated task, requiring the successful and timely installation of a variety of complex systems and mechanisms unique to each project and vital to the project's function. Installation of building components (also referred to as work packages) such as electrical systems, data exchange systems, plumbing systems, fire suppression systems, environmental controls, and so forth require careful inventory of numerous parts, permitting, testing, and inspection. In many instances, reports must be filed with multiple regulatory agencies; this is particularly true for industrial structures such as refineries, manufacturing sites, pharmaceutical plants, and nuclear installations. Documentation and monitoring of these processes is a time-consuming process that adds a significant expense to the construction and management of plants and other projects.

Traditionally, documentation of the installation and testing of such work packages is a manual process, utilizing paper forms that are assembled based on the tasks at hand, filled out on-site by different individuals, and returned for documentation and storage. Generation of documents appropriate for the unique composition of each project and gathering and tracking of related information during construction requires careful aggregation, organization, and recording of these paper records—a labor intensive and error prone process. This suggests that automation or partial automation of such documentation tasks may be useful in alleviating this problem, but implementation must be appropriate to rigorous construction environments and, preferably, be as transparent as possible to construction personnel to encourage adoption.

Various methods have been suggested for the automation of complex documentation tasks; however, their suitability for construction environments is not clear. For example, U.S. pat. publ. no. 2004/0010425 to Wilkes et al. (publ. January 2004) proposes a method for tracking patient information in a hospital setting by gathering such information in electronic form, storing the information in a hospital-wide network, and making the information available through computers and various portable electronic devices. Another example of automation of documentation tasks is found in U.S. pat. publ. no. 2010/0305997 to Ananian et al. (publ. December 2010), which describes a system where a user enters a document and a set of workflow rules into a processor, which transmits these to a second processor. When conditions triggering a workflow rule are met (e.g., the passing of a specific date), the second processor performs a specified task on the previously entered document, such as forwarding the document to a group of people via email.

While useful in controlled environments, such as a hospital setting, the vast majority of such electronic information gathering and display devices as described in these applications are not suitable for use in a construction environment. In addition, implementation of such systems would require extensive training of construction staff in their use.

U.S. pat. publ. no. 2012/0078924 to Woodings et al. (publ. March 2012) discusses a document management system in which paper documents may be entered into an information system by scanning and printable documents can be generated containing information stored on the system. However, the Woodings system fails to provide for organizational functions such as integrating tracking information directly into such generated documents.

Woodings and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for a suitable method that simplifies the task of managing building projects utilizing automation.

### SUMMARY OF THE INVENTION

The inventive subject matter provides apparatus, systems and methods in which one can readily generate sets of trackable paper forms customizable for various work packages in building projects that may be filled out on site and enter information entered into such forms and their related tracking information into an information system. Contemplated systems may automatically identify one or more components associated with a work package, automatically aggregate and optimize forms (which may have empty data fields) associated with these components, distribute these forms to a user who in turn populates the empty data fields and returns the forms, and import the information from these user-populated data fields into a work package database.

Each user-populated data field may be associated with a data identifier associating the data contained therein with, for example, a form, a component, and/or a work package. The system may automatically populate a portion of the empty data fields with information that is associated with the user to create computer-populated data fields, which can occur prior to distribution of the forms to the user.

It is further contemplated that users could customize forms by adding additional components to those specified by the system, and this step may be performed before automated aggregation and optimization of the forms associated with the work package. The system may receive a customized form from a user and add the customized form to a set of forms, which can occur prior to distributing forms to the user.

In some embodiments, a user may select a work package from a list utilizing a user interface. Similarly, a work package may be chosen from a list of work packages provided when a user selects a discipline utilizing a user interface.

In other contemplated embodiments, each form may be labeled with a unique identifier such as, for example, a barcode. The unique identifier can identify the type of work package that the form is associated with. Alternatively, the unique identifier can identify the type of component that the form is associated with.

In still other embodiments, the system may provide tracking and notification functions. For example, the system may display a report identifying which of forms that have been distributed have yet to be received. Alternatively, the system may transmit an automated alert to a user when at least one of the portion of the forms has not been received

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of the workflow of an embodiment of the inventive concept.

FIG. 2 depicts the process of selection of work packages in an embodiment of the inventive concept.

FIG. 3 depicts the process of selection of forms for a component of a selected work package in an embodiment of the inventive concept.

FIG. 4 depicts the process of review and printing of forms in an embodiment of the inventive concept.

FIG. 5 depicts the process of entry of information into a form while it is in the field and scanning of completed documents into the system in an embodiment of the invention.

FIG. 6 depicts the process of retrieval of uploaded forms and generation of reports in an embodiment of the invention.

### DETAILED DESCRIPTION

It should be noted that while the following description is drawn to a computer/server based work package processing system, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including providing automation of work package processing that integrates the use of printed forms appropriate for the rugged construction site environment and the use of data processing systems that simplify retrieval and organization of information, while providing the flexibility needed to accommodate the unique needs of each project. In addition, the use of such printed forms does not require extensive training of construction personnel and increases the acceptance of this new system.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

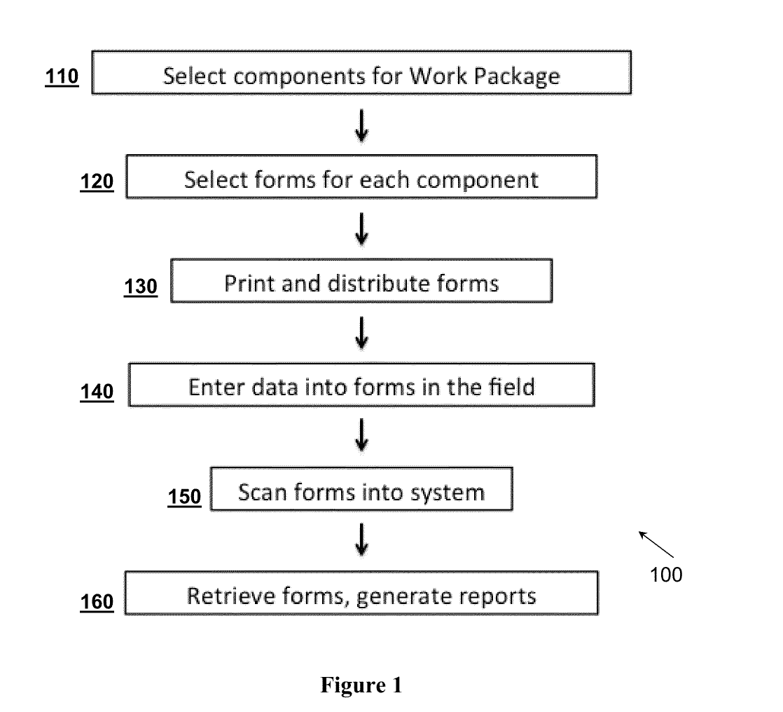

FIG. 1 depicts an overview 100 of an illustrative embodiment of the inventive concept, which begins with step 110 of selection of components that go into a work package. These components may be selected from a default list provided by the system and further customized as described below. Each component has an associated set of forms, with associated data fields that are populated as the project progresses, which can be selected in step 120. The forms may be selected from a default list provided by the system and can be further customized by the user. This degree of customization is useful in providing the degree of flexibility necessary when working with unique construction projects, with requirements that often change as the work progresses.

Once components and their associated forms have been determined, a form set is printed and distributed to workers in the field in step 130, who populate the form's data fields in step 140 as work moves forward. Information from the forms is uploaded to the system in step 150 by, for example, simply placing the completed form in a scanner and uploading its image to the system. Once the information is uploaded to the system, the information may be used to generate reports in step 160, monitor the status of the project, generate documentation necessary to support certification and licensing, and so forth.

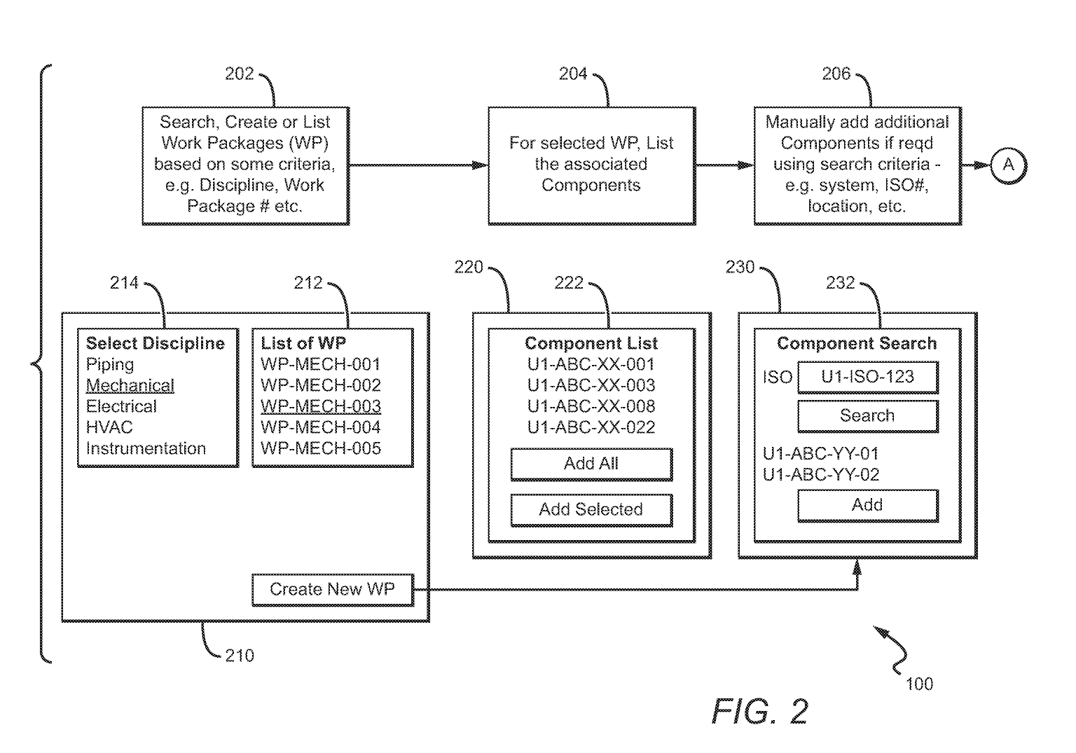

As depicted in FIG. 2, a work package, such as, for example, a high velocity air conditioning (HVAC) system, may be selected in step 202 from a list of work packages 212 supplied by system 200. Alternatively, a work package may be selected when the user selects a discipline, for example climate control, from a list 214 supplied by the system 200. In a preferred embodiment such lists are provided as part of a user interface 210, however alternate means including but not limited to selection from a list provided on a scannable form, selection via a voice recognition system, and selection via optical character recognition of written and/or typed instructions are also considered.

Selection of a work package leads to presentation of the components of the work package in step 204. The user may review these components in an interface 220, for example, and edit them as necessary to fit the requirements of the specific project. Such editing may take place both before and after construction has been initiated, thereby providing the degree of flexibility necessary to accommodate unexpected circumstances. The user can further select the desired components from the list 222, and add such components to the work package.

In some embodiments shown in step 206 of the inventive concept a user can add additional components to the work package manually, for instance by selecting such components from a set of search results 232 shown in exemplary interface 230. A user may, for example, choose to add additional or custom pieces of ductwork to an HVAC work package in order to accommodate the unique design of a particular building.

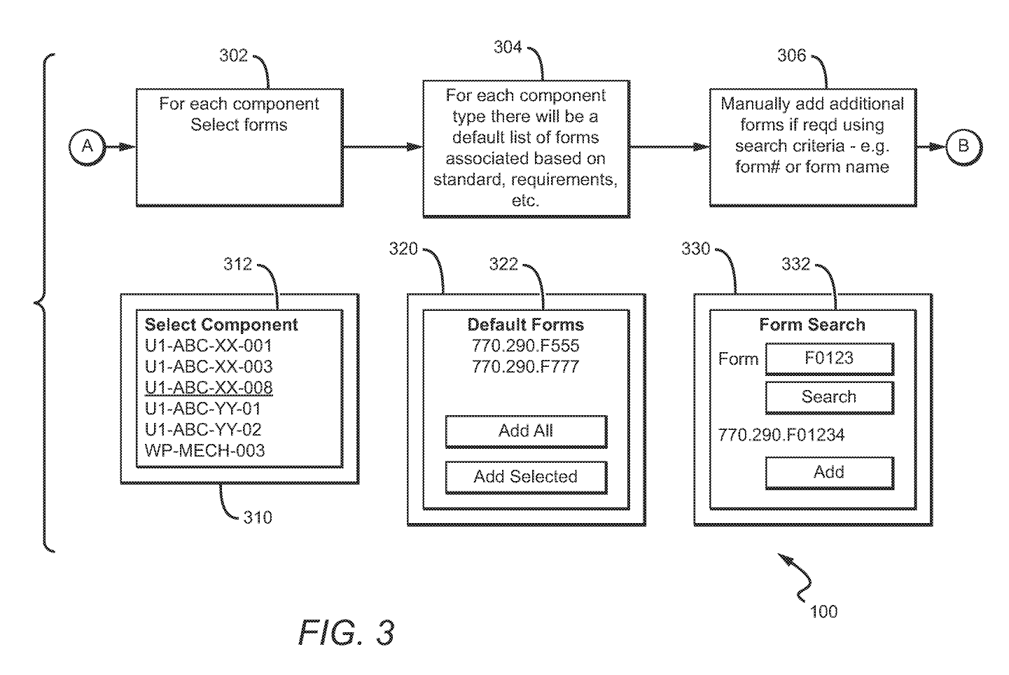

As shown in FIG. 3, each component of a work package is associated with one or more forms or documents, which are aggregated automatically by the system 300. These forms may be, for example, instructions for installation, forms necessary for acquiring necessary permits, instructions for testing, and certifications necessary for government approval. Such forms may include empty data fields. Data fields may include a data identifier that associates the data within the field with, for example, a form, a component, and/or a work package.

In some embodiments of the inventive concept the system 300 provides automated optimization of the forms. For example, the system 300 may populate one or more data fields with stored information that is associated with a user. These computer-populated data fields may be populated prior to distribution of the form.

Forms can be selected in step 302 for each component. As shown in step 304, each component or component type has a default set of forms 322 that is automatically identified and displayed in a user interface 320 by the system 300. This set of forms may also be optimized by, for example, editing by the user. In some embodiments of the inventive concept the user may edit the set of forms associated with a component both before and after the initiation of construction, thereby providing a high degree of system flexibility. The user may edit by selecting from this default list 322, and choosing such forms as are appropriate for the specific project. For example, an HVAC system for a nuclear facility may require certifications necessary for government approval that are not necessary for an HVAC system installed in an office building.

In some contemplated embodiments shown in step 306, the user may add additional forms via interface 330, for example by selecting them from a list 332 that is the result of a search. This advantageously provides an additional degree of customization of a form set to the specific project.

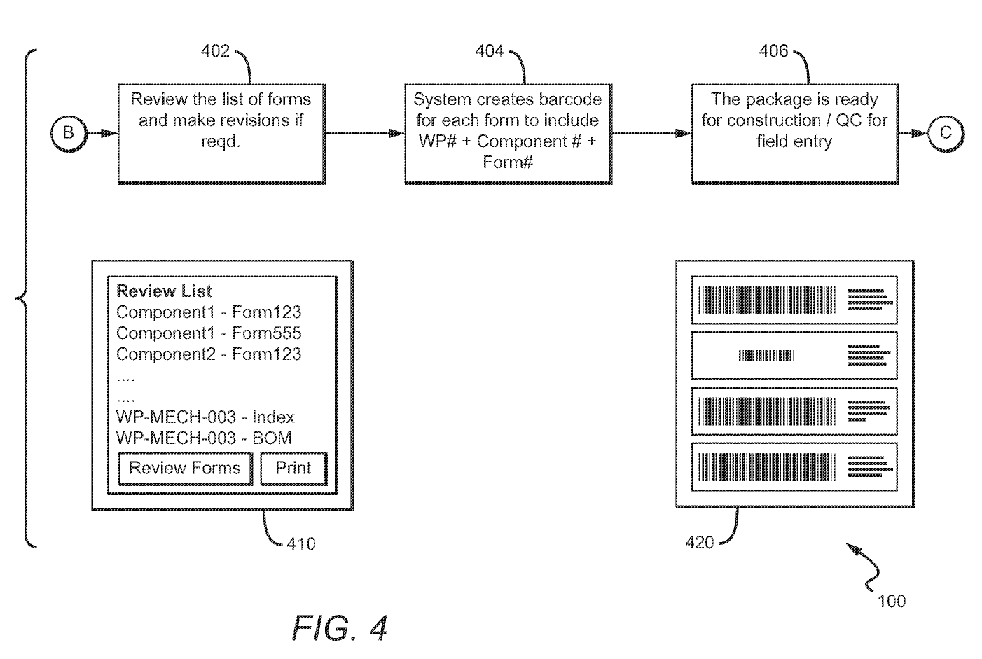

Upon completion of form selection, the system 400 allows the user to review and print the forms in step 402 as a package to be distributed to for example, construction or quality control testing personnel, as depicted in FIG. 4. The forms may be reviewed in a user interface 410 or other suitable interface. In a preferred embodiment, the system 400 includes indicia 420 that identifies a specific form and that may associate the form with a specific component, work project, and/or construction project in step 404. Although shown as a two dimensional barcode, the indicia can be a one dimensional barcode, a three dimensional bar code, a string of characters recognizable by an optical character recognition system, or any printable and machine readable code. This indicia provides tracking information, linking the information on the form with a specific component, work project, and/or construction project and providing traceability. Such information may subsequently be used for a wide variety of purposes, including but not limited to tracking progress on a particular work project, reviewing the results of quality control testing of an installed system, and in generating reports necessary for proper certification of the final installation and its components. After creating the indicia for a form, the package is ready for field entry (step 406).

Once distributed to the field, the printed forms provide an inexpensive and familiar format for data entry that is well suited to the rigors of the construction environment. Workers on the site may enter information into a form's fields in step 502 by any suitable means, for example by checking off printed boxes indicating to completion of designated tasks, by written entries that are subsequently machine read using optical character recognition, or by affixing or stamping machine readable indicia to a portion of the printed form. Training required to utilize the disclosed method is, advantageously, very minimal, as are the requirements for field equipment.

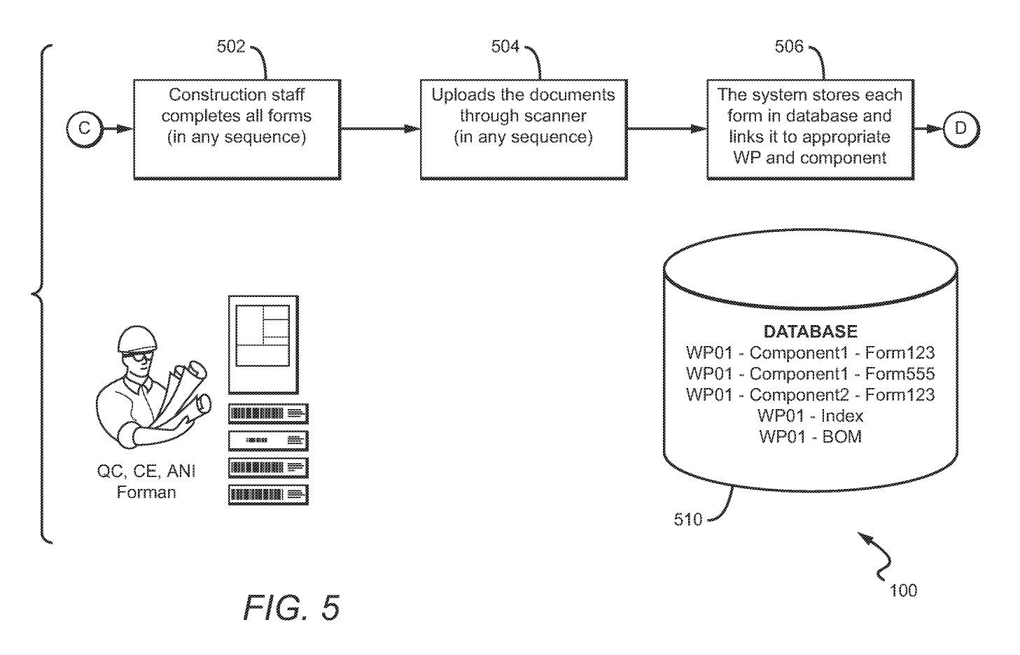

As shown in FIG. 5, completed or partially completed forms may be uploaded to the system 500 in step 504 using a document scanner or other commercially suitable device. Such scanners are widely available commercially. It is contemplated, however, that other means for imaging all or part of a form, such as a handheld scanner, a barcode reader, or a digital camera or electronic device that includes a camera function may be suitable for this purpose. In some embodiments, a portion of a form is scanned rather than the entire form, for example one or more data fields that are to be completed by a user in the field may be selectively scanned and uploaded. Portions of the form to be scanned may be designated by indicia that indicate the location of such relevant data fields, for instance by indicating the nature of the form. Alternatively, such data fields may be placed on a subset of the pages of a form and a user instructed to only upload this subset. To further minimize impact on the construction project, forms may be entered as they are completed and in any sequence. In some embodiments of the inventive concept, information related to specific forms or documents may be entered into the system without the use of a scanner, for example a request to reprint and replace a damaged form may be entered into the system directly by a user via a computer or terminal keyboard, via a telephone keypad, or entered via voice recognition following a verbal request.

Upon acquisition of the uploaded forms each form is stored in a database 510 in step 506, which links the form and/or information from fields of the form to the related work project, component of the work project, or both work project and component. In some embodiments of the inventive concept, each user-populated data field is associated with a data identifier indicating its connection with an aspect of the specific work project, including but not limited to a work package, a component, and a form. In preferred embodiments, the scanners used for data input, the database, and the devices used to access the database (e.g., computer terminals, personal computers, notebook and tablet computers, smart phones, etc.) form a single integrated system, which advantageously provides greater efficiency and providing a higher degree of data security that may be advantageous for sensitive construction projects such as nuclear facilities.

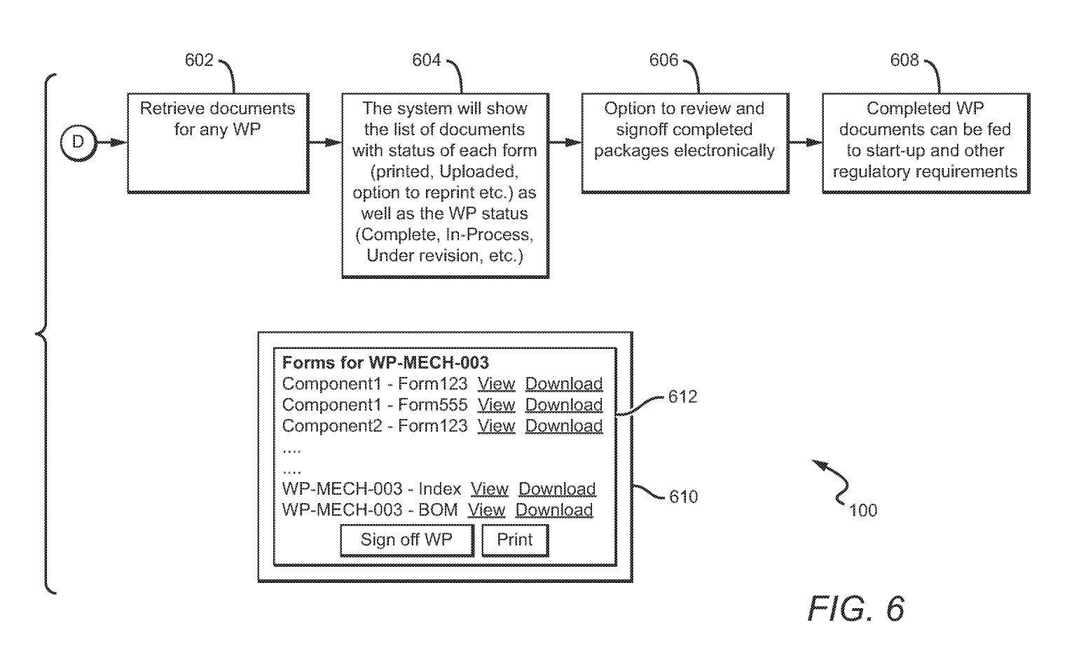

Once data from the field has been entered into the database via the scanned forms (or portions thereof), the system 100 allows a user to retrieve the desired documents for any work project in step 602 shown in FIG. 6. This functionality can serve a wide variety of purposes. A detailed status of a work project may be determined in step 604 by displaying in interface 610 a list 612 of the documents associated with the individual components of the project and the status of each, for example indicating whether a form has been printed, completed and uploaded, partially completed and uploaded (in process), if a form is missing, if a form requires revision, if a form needs to be re-printed, etc. Alternatively, such information may be aggregated to generate a status report for the work project as a whole, indicating whether it has been completed, requires revision, or is a work in progress.

In some embodiments, the system 100 can be configured to supply alerts, for example, an email message, to a user under certain conditions. Such conditions include, for example, a missing form, an incomplete or partially completed form, an approaching deadline, requests for revisions to a work project or a component thereof, and requests from the field for replacement forms or other documents. Documents stored in the system and reports generated using the system may be reviewed and approved in step 606, for example by electronic signature, and the status of such approval may also be recorded in the database. Storage and organization of such documents and reports in electronic form allows for convenient generation of sets of accurate and complete work project documents in step 608 for use by various divisions within a construction firm, contractors, and regulatory bodies, for example.

The disclosed methods and systems herein can be used in any large construction project, to thereby provide highly effective management of the paperwork involved in creating a work package and tracking, aggregating, and organizing the resulting vast quantity of completed forms. In addition, such methods and systems utilize printed forms that are well suited to the environment of a construction site without placing the burden of extensive training on field personnel. Nuclear, pharmaceutical, refineries, and other projects that require extensive documentation can benefit significantly.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of managing a work package, comprising the steps of:
automatically identifying a plurality of components associated with the work package using a work package analysis engine;
automatically aggregating and optimizing a plurality of forms associated with the plurality of components using the work package analysis engine, wherein the plurality of forms has empty data fields;
distributing a portion of the plurality of forms to a user;
receiving the portion of the forms from the user, wherein the portion of the forms have user-populated data fields; and
importing the user-populated data fields into a work package database.

2. The method of claim 1, further comprising receiving a customized component from the user and adding the customized component to the plurality of components.

3. The method of claim 2, wherein the step of receiving the customized component occurs before the step of aggregating and optimizing the plurality of forms associated with the plurality of components.

4. The method of claim 1, further comprising configuring a user interface using the work package analysis engine to allow the user to select the work package from a list of work packages.

5. The method of claim 4, wherein the user interface allows the user to select a discipline from a list of disciplines to produce the list of work packages.

6. The method of claim 1, further comprising receiving a customized form from the user and adding the customized form to the plurality of forms.

7. The method of claim 6, wherein the step of receiving the customized form occurs before the step of distributing a portion of the plurality of forms to the user.

8. The method of claim 1, further comprising automatically populating a portion of the empty data fields with information associated with the user to create computer-populated data fields.

9. The method of claim 8, wherein the step of automatically populating the portion of the empty data fields occurs before the step of distributing the portion of the plurality of forms to the user.

10. The method of claim 1, further comprising associating each form with a unique identifier using the work package analysis engine.

11. The method of claim 10, wherein the unique identifier identifies the type of work package with which the form is associated.

12. The method of claim 10, wherein the unique identifier identifies the type of component with which the form is associated.

13. The method of claim 10, wherein the unique identifier is a barcode.

14. The method of claim 1, wherein the step of importing the user-populated data fields into the database comprises associating each user-populated data field with a data identifier selected from the group consisting of a form, a component, and a work package.

15. The method of claim 1, further comprising using the work package analysis engine to configure a user interface to present a report identifying which of the forms have yet to be received.

16. The method of claim 1, further comprising sending an automated alert to the user when at least one of the portion of the forms has not been received.
